(19) United States
(12) Patent Application Publication
(10) Pub. No.: US 2014/0315417 A1
(43) Pub. Date: Oct. 23, 2014

(54) TERMINAL STRUCTURE

(71) Applicant: Yazaki Corporation, Minato-ku, Tokyo (JP)

(72) Inventors: Yoshimi Wada, Makinohara-shi (JP); Kaoru Sawa, Makinohara-shi (JP); Tomoyuki Kasajima, Ohta-ku (JP)

(73) Assignee: Yazaki Corporation, Minato-ku, Tokyo (JP)

(21) Appl. No.: 14/364,170

(22) PCT Filed: Dec. 27, 2012
(86) PCT No.: PCT/JP2012/084301

§ 371 Date: Jun. 10, 2014

(30) Foreign Application Priority Data
Dec. 28, 2011 (JP) 2011-288585

(51) Int. Cl. H01R 13/432

(52) U.S. Cl. CPC H01R 13/432
USPC 439/357

(57) ABSTRACT

A terminal structure to be locked to a terminal locking lance which is provided in a cavity of a connector housing, includes: a box part formed in a shape of a rectangular tube, including an outer bottom plate, outer side walls, an upper plate, an inner bottom plate formed inside the outer bottom plate, and an inner side wall formed inside one of the outer side walls, the box part including a contact to be in contact with a male terminal tab adapted to be inserted into the box part; and a locking protrusion including: a locking plate extended from an end of the outer side wall so as to be in parallel with the upper plate above the upper plate and adapted to be in contact with the terminal locking lance; and a stamped-out part in contact with the upper plate.

### TECHNICAL FIELD

The present invention relates to a terminal structure to be locked to a terminal locking lance which is provided in a cavity of a connector housing.

### BACKGROUND ART

As a terminal structure to be locked to a terminal locking lance which is provided in a cavity of a connector housing, there has been heretofore proposed such a structure that a retaining projection is formed on a wall part of a terminal metal fitting by stamping, and this retaining projection is locked to the terminal locking lance, as disclosed, for example, in PTL 1.

FIGS. 12 to 15 show the terminal metal fitting and a connector which are disclosed in PTL 1. FIG. 12 is a side view of the terminal metal fitting, FIG. 13 is a longitudinal sectional view of a part of the terminal metal fitting, FIG. 14 is a cross sectional view of the terminal metal fitting, and FIG. 15 is a sectional view of the connector.

In these drawings, the terminal metal fitting includes a box part 1 in a shape of a rectangular tube and a wire crimping part 2. The box part 1 includes a pair of side walls 4, 5 which are extended downward from both side edges of an upper wall 3, a lower wall 6 which is horizontally extended from a lower end edge of one of the side walls 4, and a reinforcing wall 7 which is horizontally extended from a lower end edge of the other side wall 5 to be superposed on an inner face of the lower wall 6. A contact 8 is formed on an inner face of the reinforcing wall 7, and further, a spring part 9 and a contact 10 are provided at a position opposed to the contact 8.

Electrical connection is established, by clamping a male terminal tab which is inserted into the box part 1, between the contact 8 and the contact 10.

A stamping work is applied to a center part in a lateral direction of the lower wall 6 in such a manner that a retaining projection 11 is formed so as to protrude downward. A connector housing 12 as shown in FIG. 15 is formed of synthetic resin material, and a cavity 13 into which a terminal metal fitting as shown in FIG. 12 is adapted to be inserted is formed inside the connector housing 12.

A terminal locking lance 14 formed of resin and adapted to be engaged with the retaining projection 11, when the terminal metal fitting is inserted, is formed inside the cavity 13. The terminal metal fitting is retained inside the cavity 13 by locking operation between the retaining projection and the terminal locking lance 14.

### CITATION LIST

### Patent Literature

[PTL 1] JP-A-2002-190342

### SUMMARY OF INVENTION

### Technical Problem

In the terminal structure which is shown in FIGS. 12 to 15, the retaining projection 11 for locking and retaining the terminal metal fitting inside the cavity 13 is formed by the stamping work. Therefore, a contact area with respect to the terminal locking lance 14 cannot be secured, and deterioration of a terminal retaining force is concerned.

The invention has been made in order to solve the above described problem, and an object of the invention is to provide a terminal structure capable of securing a stable locking force (a terminal retaining force) with respect to a terminal locking lance.

### Solution to Problem

According to an aspect of the invention, there is provided a terminal structure to be locked to a terminal locking lance which is provided in a cavity of a connector housing, the terminal structure comprising: a box part which is formed in a shape of a rectangular tube, including an outer bottom plate, outer side walls, an upper plate, an inner bottom plate which is formed inside the outer bottom plate, and an inner side wall which is formed inside one of the outer side walls, the box part including a contact to be in contact with a male terminal tab which is adapted to be inserted into the box part; and a locking protrusion including: a locking plate which is extended from an end of the outer side wall so as to be in parallel with the upper plate above the upper plate and which is adapted to be in contact with the terminal locking lance; and a stamped-out part which is in contact with the upper plate.

The stamped-out part may be stamped out from the locking plate so as to be contacted with the upper plate.

The stamped-out part may include: a convex part which is in contact with the upper plate; and a concave part.

According to the above described structure, the locking plate is supported by a convex part of the stamped-out part which is stamped out from the locking plate so as to be contacted with the upper plate of the box part, and deformation of the locking plate is restrained. As the results, it is possible to secure a stable locking force (a terminal retaining force) with respect to the terminal locking lance.

Accordingly, even in case where the locking plate is formed long in a lateral direction of the upper plate of the box part, the locking plate does not fall down, and a locking area can be increased.

The stamped-out part may be stamped out, including an end of the locking plate at a side to be in contact with the terminal locking lance.

According to the above described structure, an area of a contact face of the locking plate to be contacted with the terminal locking lance is a sum of a region of the convex part of the stamped-out part, a region which is not stamped out, and a part where the region of the convex part is continued to the region which is not stamped out. Therefore, the locking area is increased by a region of the continued part, and the locking force is increased.

Moreover, by making a stamping length of the stamped-out part longer (specifically, a height of the convex part is made larger), the region of the continued part is increased. As the results, the locking area is further increased, and the locking force is increased.

### Advantageous Effects of Invention

According to an aspect of the invention, the locking plate is supported by the convex part of the stamped-out part which is stamped out from the locking plate so as to be contacted with the upper plate of the box part, and deformation of the locking plate is restrained. As the results, it is possible to secure a stable locking force (a terminal retaining force) with respect to the terminal locking lance.

According to an aspect of the invention, the locking area with respect to the terminal locking lance is increased, and therefore, the locking force is increased.

### BRIEF DESCRIPTION OF DRAWINGS

FIG. 1 is a perspective view of a terminal structure in an embodiment according to the invention.

FIG. 2 is a perspective view showing in section a box part of the terminal structure in the embodiment according to the invention.

FIG. 3 is a developed view of the box part of the terminal structure in the embodiment according to the invention.

FIG. 4 is a longitudinal sectional view of the box part of the terminal structure in the embodiment according to the invention.

FIG. 5 is a longitudinal sectional view showing a state where a male terminal tab is inserted into the box part of the terminal structure in the embodiment according to the invention.

FIG. 6 is a longitudinal sectional view showing positional relation between the box part of the terminal structure in the embodiment according to the invention and a terminal locking lance.

FIG. 7 is a sectional view as seen from a direction of arrow marks A-A in FIG. 6.

FIG. 8 is a sectional view as seen from a direction of arrow marks B-B in FIG. 6.

FIG. 9 is a perspective view showing in section a box part of a terminal structure in another embodiment according to the invention.

FIG. 10 is a longitudinal sectional view showing positional relation between the box part of the terminal structure in the other embodiment of the invention and a terminal locking lance.

FIG. 11 is a sectional view as seen from a direction of arrow marks C-C in FIG. 10.

FIG. 12 is a side view showing an example of a related-art terminal metal fitting.

FIG. 13 is a longitudinal sectional view showing a part of the related-art terminal metal fitting.

FIG. 14 is a cross sectional view of the related-art terminal metal fitting.

FIG. 15 is a sectional view showing an example of a related-art connector.

### DESCRIPTION OF EMBODIMENTS

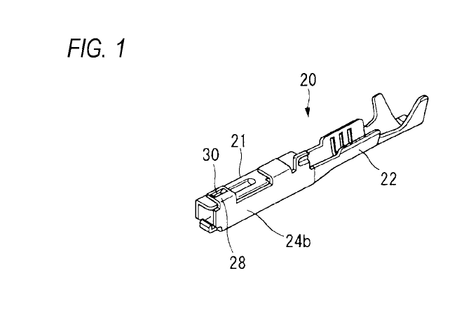

Now, embodiments according to the invention will be described referring to the drawings. However, the invention is not limited to the below described embodiments. The embodiments are applied to a terminal structure to terminal metal fitting) to be locked to the terminal locking lance which is provided in the cavity 13 of the connector housing 12, as shown in FIG. 15. FIGS. 1 to 8 show one example of the embodiments, and FIGS. 9 to 11 show another example of the embodiments.

FIG. 1 is a perspective view showing a female terminal 20 which is an embodiment of the terminal structure according to the invention. The female terminal 20 has a box part 21 in a shape of a rectangular tube into which a male terminal tab is inserted, and a wire crimping part 22 which is formed continuously from the box part 21.

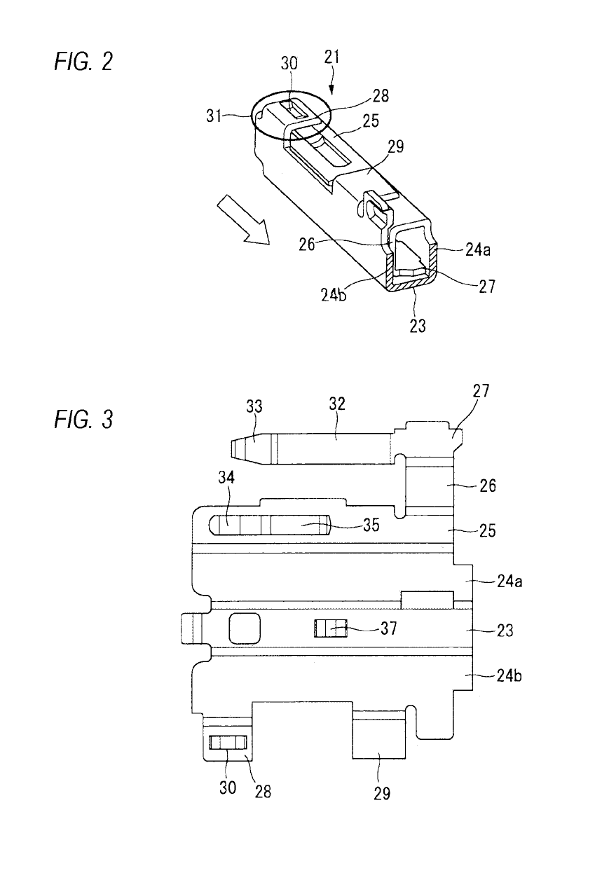

Referring to FIG. 2 which is a perspective view showing in section the box part 21 which is cut at a position continued to the wire crimping part 22, FIG. 3 which is a developed view, and FIG. 4 which is a longitudinal sectional view, numeral 23 represents an outer bottom plate.

A pair of outer side walls 24a, 24b are extended upward from both side ends in a lateral direction of this outer bottom wall 23. An upper plate 25 is horizontally extended from an upper end edge of one of the outer side walls 24a, an inner side wall 26 is extended downward from an end of the upper plate 25 at a side adjacent to the outer side wall 24b, and an inner bottom plate 27 is horizontally extended from an end of the inner side wall 26 at a side adjacent to the outer bottom plate 23.

Accordingly, the inner side wall 26 is superposed on an inner face of the outer side wall 24b, and the inner bottom plate 27 is superposed on an inner face of the outer bottom plate 23.

A predetermined range of the outer side wail 24b at an insertion side of the male terminal tab is extended upward higher than the upper plate 25 by a predetermined length, and a locking plate 28 is horizontally extended from an extended end thereof. Moreover, a predetermined range of the outer side wall 24b at a side close to the wire crimping part 22 is folded so as to be superposed on the upper plate 25 thereby to form a folded part 29. Namely, the locking plate 28 is provided above to the upper plate 25.

A stamped-out part 30 is formed in a predetermined range of the locking plate 28 at its center part, by stamping out the locking plate 28 toward the upper plate 25 by a predetermined length, so as to be contacted with the upper plate 25.

A locking protrusion 31 is formed by a combination of the locking plate 28 which is extended from the outer side wall 24b and the stamped-out part 30.

The inner bottom plate 27 is provided with a spring part 32, as shown in FIGS. 3 and 4, and a contact 33 is formed at an end of the spring part 32.

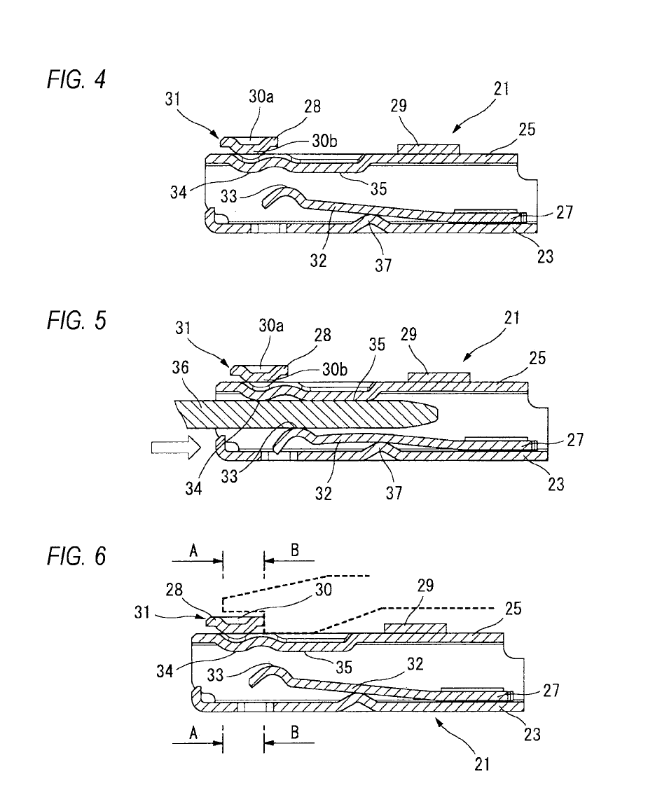

Contacts 34, 35 are formed on an inner face of the upper plate 25 which is opposed to the contact 33, and electrical connection is established, by clamping a male terminal tab 36 which is inserted into the box part 21 between these contacts 33, 34, 35, as shown in FIG. 5.

Numeral 37 represents a protruded part which is formed by protruding the outer bottom plate 23 toward the spring part 32.

By applying a stamping work to the stamped-out part 30, a concave part 30a and a convex part 30b are formed, as shown in FIGS. 4 and 5.

FIG. 6 shows a state where the female terminal 20 is locked to the terminal locking lance, which is shown by a broken line in the drawing, inside the cavity of the connector housing.

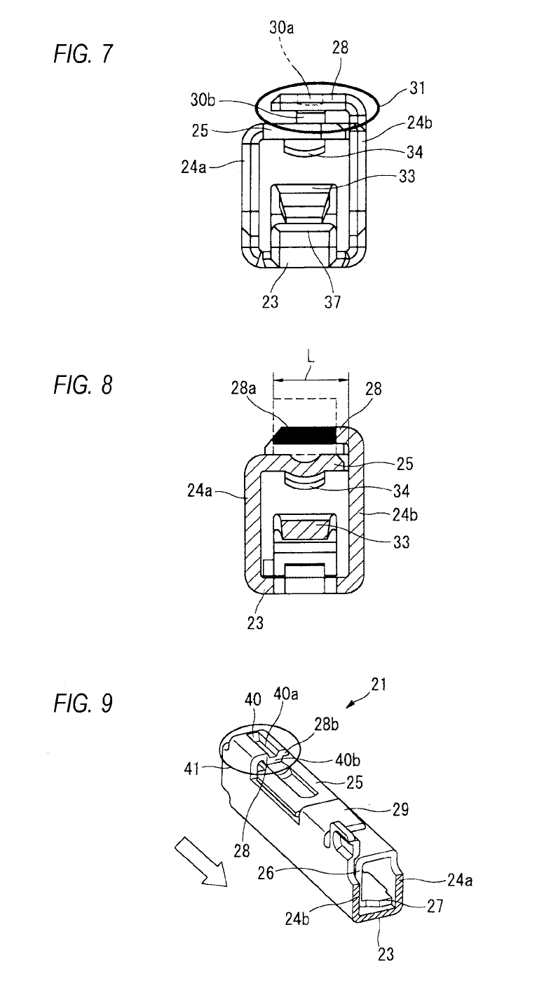

FIG. 7 is a sectional view as seen from a direction of arrow marks A-A in FIG. 6, and FIG. 8 is a sectional view as seen from a direction of arrow marks B-B in FIG. 6. A black painted region of the locking plate 28 in FIG. 8 shows a locking contact face 28a which represents a contact area (a locking area) with respect to the terminal locking lance.

The locking plate 28 is supported by the convex part 30b of the stamped-out part, and therefore, deformation of the locking plate 28 is restrained. In this manner, a stable locking force (a terminal retaining force) is secured between the locking plate 28 and the terminal locking lance.

As the results, even in case where a size L of the locking plate 28 in a lateral direction is formed long along a lateral direction of the upper plate 25, the locking plate 28 does not fall down, and therefore, by making the length L longer, a locking area (an area of the locking contact face 28a, as shown by the black pained region) can be increased. In this manner, it is possible to enhance the terminal retaining force.

In another embodiment of the invention, the stamped-out part of the locking protrusion is stamped out, including an end of the locking plate 28 at a side to be contacted with the terminal locking lance, in a form of a stamped-out part 40 which is shown in FIGS. 9 to 11. It is to be noted that in FIGS. 9 to 11, the same members as those in FIGS. 1 to 8 are denoted with the same reference numerals.

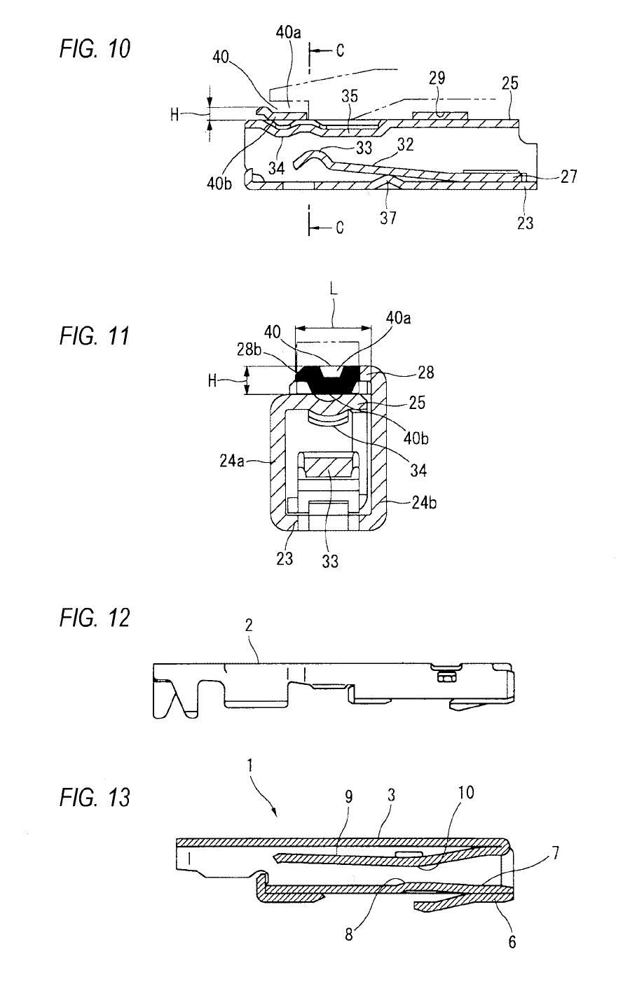

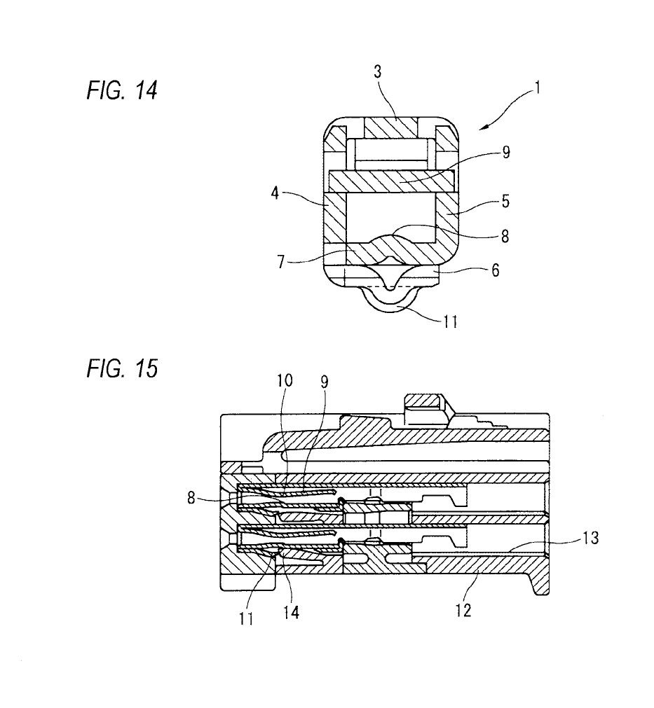

FIG. 9 is a perspective view showing a box part 21 of a female terminal 20 in the other embodiment, FIG. 10 is a longitudinal sectional view of the box part 21, in a state locked to the terminal locking lance which is shown by a two dot chain line, and FIG. 11 is a sectional view as seen from a direction of arrow marks C-C in FIG. 10.

In these drawings, numeral 40a represents a concave part of the stamped-out part 40, and numeral 40b represents a convex part of the stamped-out part 40.

In this embodiment, a locking protrusion 41 is formed by a combination of the locking plate 28 and the stamped-out part 40.

The stamped-out part 40 is stamped out including the end of the locking plate 28 at a side to be contacted with the terminal locking lance, and therefore, a locking contact face 28b which is thus formed has a shape including the convex part 40b, as shown by a black painted region in FIG. 11.

As the results, the locking contact face 28b in this embodiment has a larger contact area (a locking area) with respect to the terminal locking lance, as compared with the locking contact face 28a in the embodiment as shown in FIGS. 1 to 8, and hence, the locking force (terminal retaining force) can be enhanced.

Specifically, an area of the locking contact face 28b in this embodiment is a sum of a region of the convex part 40b of the locking plate 28, a region which is not stamped out (a horizontal part), and a part where the region of the convex part 40b is continued to the region which is not stamped out (a slanted part). Therefore, the locking area is increased by a region of the continued part, and the locking force is further increased.

Therefore, by making a stamping length of the stamped-out part 40, that is, a height H of the convex part 40b larger, the region of the continued part (the slanted part) is increased. As the results, the locking area is further increased, and the locking force is increased.

The present application is based on Japanese Patent Application No. 2011-288585 filed on Dec. 28, 2011, the contents of which are incorporated herein by way of reference.

### INDUSTRIAL APPLICABILITY

According to an aspect of the invention, there is provided a terminal structure capable of securing a stable locking force (a terminal retaining force) with respect to a terminal locking lance.

### REFERENCE SIGNS LIST

20 Female terminal
21 Box part
22 Wire crimping part
23 Outer bottom plate
24a, 24b Outer side wall
25 Upper plate
26 Inner side wall
27 Inner bottom plate
28 Locking plate
28a, 28b Locking contact face
29 Folded part
30, 40 Stamped-out part
30a, 40a Concave part
30b, 40b Convex part
31, 41 Locking Protrusion
32 Spring part
33, 34, 35 Contact
36 Male terminal tab
37 Protruded part

1. A terminal structure to be locked to a terminal locking lance which is provided in a cavity of a connector housing, the terminal structure comprising:
a box part which is formed in a shape of a rectangular tube, including an outer bottom plate, outer side walls, an upper plate, an inner bottom plate which is formed inside the outer bottom plate, and an inner side wail which is formed inside one of the outer side walls, the box part including a contact to be in contact with a male terminal tab which is adapted to be inserted into the box part; and
a locking protrusion including: a locking plate which is extended from an end of the outer side wall so as to be in parallel with the upper plate above the upper plate and which is adapted to be in contact with the terminal locking lance; and a stamped-out part which is in contact with the upper plate.

2. The terminal structure according to claim 1, wherein the stamped-out part is stamped out from the locking plate so as to be contacted with the upper plate.

3. The terminal structure according to claim 2, wherein the stamped-out part is stamped out, including an end of the locking plate at a side to be in contact with the terminal locking lance.

4. The terminal structure according to claim 1, wherein the stamped-out part includes: a convex part which is in contact with the upper plate; and a concave part.
